(19) United States
(12) Patent Application Publication
(10) Pub. No.: US 2003/0106778 A1
(43) Pub. Date: Jun. 12, 2003

(54) Bottle indexing wheel with radially resilient teeth

(76) Inventor: Richard Francis Hurst, Vero Beach, FL (US)

Correspondence Address: Richard F. Hurst, Box 6400, Vero Beach, FL, 32961-6400, US

(21) Appl. No.: 10/012,068

(22) Filed: Dec. 11, 2001

(51) Int. Cl. B65G 35/00

(52) U.S. Cl. 198/723

(57) ABSTRACT

A method and apparatus are provided to protect bottles from damage upon tangentially entering an index wheel track by means of retractable radially resilient teeth on a bottle indexing wheel.

### FIELD OF THE INVENTION

The present invention relates to index wheels of the type adapted to re-orient bottles from a tangent forward-resilient single-file linear row of bottles into an arcuate index wheel track formed by a larger diameter fixed position peripheral bottle guide and a smaller diameter concentric rotatable multi-pocketed bottle index wheel.

More particularly, the present invention relates to a pocketed bottle indexing wheel wherein said pockets comprise the space between two radially resilient teeth which protrude in an organized radial array from the outer edge of said indexing wheel into the index wheel track to sequentially: 1, select the lead bottle from a forward-resilient single-file linear row of bottles, and, 2, push said bottles around said arcuate track to an index wheel exit area.

Heretofore, the initial contact of a fixed position index wheel tooth against a bottle tangentially entering an index wheel track occurred in three bottle strike areas:

1. Initial contact anywhere on the lead presented quadrant of a bottle, the consequence of which is the unproductive circumstance of the contacting index wheel tooth pushing the bottle backwards against the rotating direction of the index wheel.

2. Initial contact anywhere on the trailing presented quadrant of a bottle, the consequence of which is the favorable circumstance of the contacting index wheel tooth pushing the bottle forward.

3. Initial contact at the exact point between the lead and trailing quadrants of the bottle which point is presented only when the diameter of the bottle and the radius of the index wheel center to the outermost tip of the contacting index wheel tooth share a common axis.

The consequence of this action is to jamb the bottle between the index wheel tooth and the fixed position peripheral guide and cause possible bottle damage.

The teeth of the present invention Bottle Index Wheel are radially resilient, so that, under radial pressure, they retract from their protruding position away from the index wheel track thereby completely eliminating bottle jamming and the possibility of bottle damage.

The present invention is of particular importance in the pharmaceutical packaging industry where large numbers of vials, bottles, and ampoules are commonly pushed and positioned by bottle indexing wheels.

### DESCRIPTION OF PRIOR ART

The novelty of the present invention consists of a method and apparatus to prevent damage to bottles tangentially entering an arcuate index wheel track. The invention comprises a plurality of resilient teeth in a geometric array radially protruding from an index wheel and adapted to sequentially select the lead tangential bottle from a single-file linear row of forward resilient bottles and push said bottle around an arcuate track. Jamming of said lead bottle in the index wheel track is eliminated as resilient teeth retract under radial pressure before any damage can be done.

Fixed position index wheels to feed bottles have long been used in packaging machinery and are available commercially. Such index wheels are fully described in Kouda U.S. Pat. No. 5,695,041, Hurst U.S. Pat. No. 6,089,001 and Wilson U.S. Pat. No. 6,276,374. None of these bottle index wheels, however, have radially resilient retractable teeth to prevent bottle jamming.

Jamming and crushing of a lead bottle entering the index wheel track have been a traditional problem. Prior art includes various bottle separating devices to time the entry of a lead bottle into fixed position pocketed index wheels so as to prevent striking the lead bottle to cause a jamming condition. These devices include commercially available timing screws and lugged conveyors, all of which add cost, space, complexity and expense over the present invention.

### SUMMARY OF THE INVENTION

It is a principle object of the present invention to prevent damage to bottles upon tangentially entering a bottle indexing wheel track.

It is a principle object of the present invention to provide bottle indexing wheel with a plurality of radially resilient retractable teeth protruding from said wheel for the purpose of sequentially selecting the lead bottle in a forward resilient row of bottles with one of said teeth, and retracting if said lead bottle exerts a radial force toward said tooth, or, remaining extended and pushing said lead bottle forward and away from said row of bottles.

It is a principle object of the present invention to prevent damage to the lead bottle in a single-file row of forward resilient bottles when selected to be pushed through an arcuate index wheel track by means of a rotatable bottle index wheel with radially resilient retractable teeth protruding from the outer edge of said wheel, thereby eliminating bottle damage when the radius from the center of said index wheel to the tip of a bottle selecting retractable tooth and the diameter of the bottle selected share a common axis.

### DESCRIPTION OF THE PREFERRED EMBODIMENT

Refer now to FIG. 1, showing an overhead view of the essential parts of a preferred embodiment BOTTLE INDEXING WHEEL WITH RADIALLY RESILIENT TEETH apparatus.

Apparatus 1 includes Fixed Position Outer Guide 2, forming a Bottle Track 16 in three sections including a tangential bottle infeed linear channel cooperative with Fixed Position Infeed Guide 3, a tangential bottle exiting linear channel cooperative with Fixed Position Exit Guide 4, and an arcuate channel opposite Index Wheel 5. All guides are attached to a common deck not shown.

Index Wheel 5, atop common deck not shown, is mounted on Index Wheel Shaft 6 and driven in clockwise rotation by a standard drive motor not shown.

Selector Tooth at 12 O'clock 7 is shown on a Common Radial Axis 18 with Lead Bottle 12 as resiliently pushed forward by supported by Fixed Position Outer Guide 2, and pushed by Bottles In Single-file Forward Resilient Row 13, exerts radial pressure on Selector Tooth at 12 O'Clock 7, causing compression of resilient Selector Tooth Spring 8 and allowing retraction of Selector Tooth at 12 O'clock 7 within Selector Tooth Housing 9.

Fully extended by Pushing Tooth Spring 11, Pushing Tooth at 3 O'clock 10 pushes Bottle 14 forward along the arcuate section of Bottle Track 16.

Exiting Bottle 15 is shown as disengaging from fully extended Pushing Tooth at 6 O'clock 17.

In operation a Selector Tooth at 12 O'clock 7 in clockwise rotation either passes in front of Lead Bottle 12, is retracted by radial pressure from Lead Bottle 12, or, in full extension, pushes Lead Bottle 12 along the arcuate section of Bottle Track 16.

From the aforementioned description it is clearly understood that the retraction of the Selector Tooth at 12 O'clock eliminates damage to Lead Bottle 12 when Lead Bottle 12 and Selector Tooth at 12 O'clock share a Common Radial Axis 18.

### BRIEF DESCRIPTION OF THE DRAWING

FIG. 1 is an overhead view of one preferred embodiment apparatus for sequentially selecting the lead bottle from a forward resilient single-file row of bottles with a radially resilient retractable bottle selecting or pushing tooth as mounted on a bottle index wheel. The lead bottle of FIG. 1 is shown to be having a common radial axis with said tooth.

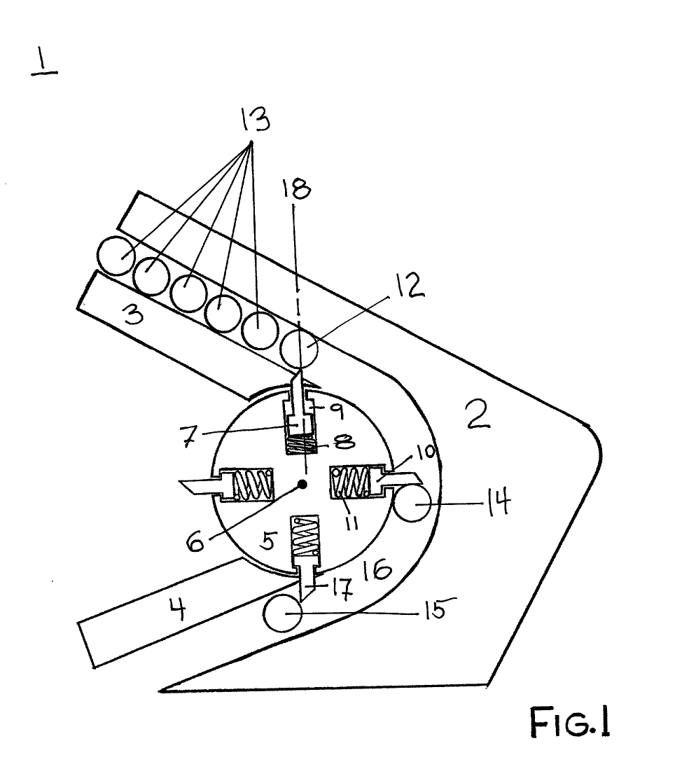

What is claimed:

1. The method and apparatus of eliminating bottles from damage upon tangentially entering an index wheel track by means of protruding retractable resilient teeth radially mounted on a rotatable bottle indexing wheel.

2. The claim of claim 1 wherein said resilient teeth either retract upon contact with a lead bottle in a forward resilient tangential row of bottles, bypass said lead bottle upon contact, or, upon contact, select and push said lead bottle along an arcuate track formed by said index wheel and a fixed position juxtapose peripheral guide.
